(19) United States
(12) Patent Application Publication
(10) Pub. No.: US 2007/0071662 A1
(43) Pub. Date: Mar. 29, 2007

(54) FUEL REFORMER FOR FUEL CELL APPARATUS

(75) Inventors: Shinya Kawakita, Tokyo (JP); Ryo Anraku, Tokyo (JP); Masashi Ogino, Tokyo (JP); Osamu Nakamura, Tokyo (JP); Tsutomu Terazaki, Tokyo (JP)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignees: Nippon Sheet Glass Company, Limited, Tokyo (JP); CASIO COMPUTER CO., LTD., Tokyo (JP)

(21) Appl. No.: 11/535,171

(22) Filed: Sep. 26, 2006

(30) Foreign Application Priority Data
Sep. 27, 2005 (JP) 2005-280019

(51) Int. Cl. B01J 8/00

(52) U.S. Cl. 422/199

(57) ABSTRACT

A fuel cell fuel reformer including a gas reactor for producing reformed fuel and an electric heater for heating the gas reactor. An external container includes an inner vacuum chamber, which accommodates the gas reactor and the electric heater, and receiving portions. An electric wire extends through the external container to supply electric power to the electric heater in the inner vacuum chamber. Fluid tubes are received by the receiving portions and extend through the external container. A sealant seals gaps between the fluid tubes and the receiving portions. The gas reactor, the fluid tubes, the external container, and the sealant each have thermal expansion coefficients, with the maximum one of the thermal expansion coefficients being ten-times the minimum one of the thermal expansion coefficients or less.

### CROSS-REFERENCE TO RELATED APPLICATIONS

This application is based upon and claims the benefit of priority from prior Japanese patent application No. 2005-280019, filed on Sep. 27, 2005, the entire contents of which are incorporated herein by reference.

### BACKGROUND OF THE INVENTION

The present invention relates to a fuel reformer for fuel cell apparatuses for reforming a fuel such as natural gas or methanol into hydrogen rich gas.

Progress has been made for the application of fuel cell apparatuses in highly energy-efficient power generation systems expected to solve environmental issues and natural resource saving issues. In recent years, attempts have been made to use fuel cell apparatuses also as a power source for portable electronic equipment. In order to enable fuel cell apparatuses to be used in portable equipment, however, further technological development is required for providing effective heat insulation and reducing energy loss under strict conditions resulting from the need for smaller and lighter equipment.

Japanese Laid-Open Patent Publication No. 8-12301 (Patent Publication 1) describes a compact fuel reformer for producing hydrogen from methanol for the purpose of providing a mobile power source. Japanese Laid-Open Patent Publication No. 2001-229949 (Patent Publication 2) describes a technique for reducing the size of a fuel cell apparatus with the use of a fuel reformer.

However, the fuel reformers of the prior art described in the patent publications result in a large energy loss and require a large amount of energy to keep a gas reactor at a temperature of 200° C. to 400° C.

For example, the methanol reformer described in Patent Publication 1 uses oblate-cross sectional steel tubes as fluid tubes for through which methanol enters and exits. The fuel cell apparatus described in Patent Publication 2 includes a fuel cell power generation module, which is accommodated in a vacuum chamber, and a tube, which supplies fuel gas such as hydrogen to the power generation module. The tube extends through the power generation module.

In the prior art, a metal or alloy (stainless steel, copper, or KOVAR (registered trademark)) is used in a contact portion between a fluid tube and an external container or in a contact portion between the reactor and the external container (reactor support). The use of a material having high heat conductivity such as a metal or alloy in the contact portion as described above increases the energy loss due to heat conduction. This results in low energy efficiency of the conventional fuel reformers.

### SUMMARY OF THE INVENTION

It is therefore an object of the present invention to reduce the energy loss in a fuel reformer for fuel cell apparatuses.

One aspect of the present invention is a fuel cell fuel reformer for use with nonreformed fuel. The fuel cell fuel reformer includes a gas reactor for reforming non-reformed fuel to produce reformed fuel. An electric heater heats the gas reactor. An external container includes an inner vacuum chamber for accommodating the gas reactor and the electric heater. The external container further includes a plurality of receiving portions. An electric wire extends through the external container to supply electric power to the electric heater in the inner vacuum chamber. A plurality of fluid tubes are respectively received by the receiving portions and extend through the external container. At least one of the fluid tubes supply the non-reformed fuel to the gas reactor in the inner vacuum chamber, and at least another one of the fluid tubes discharge the reformed fuel produced by the gas reactor. A sealant seals gaps between the fluid tubes and the receiving portions. The gas reactor, the fluid tubes, the external container, and the sealant each have thermal expansion coefficients, with one of the coefficients being a maximum and another one being a minimum relative to the other coefficients. The maximum one of the thermal expansion coefficients being no greater than ten times the minimum one of the thermal expansion coefficients.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a cross-sectional view showing a fuel reformer for a portable fuel cell apparatus according to a preferred embodiment of the present invention;

FIG. 2 is a cross-sectional view of the fuel reformer taken along line 2-2 of FIG. 1;

FIG. 3 is a cross-sectional view showing a joint structure between a fluid tube and the reformer body;

FIGS. 4A to 4F and FIGS. 5A to 5C show examples of the arrangement of fluid tubes in the fuel reformer; and

FIG. 6 is a cross-sectional view showing a tube assembly of fluid tubes.

### DESCRIPTION OF THE PREFERRED EMBODIMENTS

The inventors of the present invention have found that energy loss in a fuel reformer for a compact fuel cell apparatus accommodating a heat-generating gas reactor is caused by the following three phenomena:

(1) heat conduction caused by convection of gas such as air;

(2) infrared radiation from a heating element; and

(3) heat conduction caused by direct contact between reactor components.

The present inventors have considered the following three measures in order to reduce the energy loss caused by the three phenomena described above.

(a) The enclosure of a heating element in an external container to prevent contact between the heating element and a gas flow.

(b) The arrangement of an infrared ray reflecting film on the inner surface of the external container to reduce infrared radiation.

(c) The reduction of heat conduction by decreasing the contact area between the heating element and the external container while interposing a low-conductivity material between the reactor components, which are in contact with each other.

The inventors of the present invention have found that measure (c) is particularly efficient and completed the present invention accordingly.

Preferred embodiments of the present invention will be described with reference to the drawings.

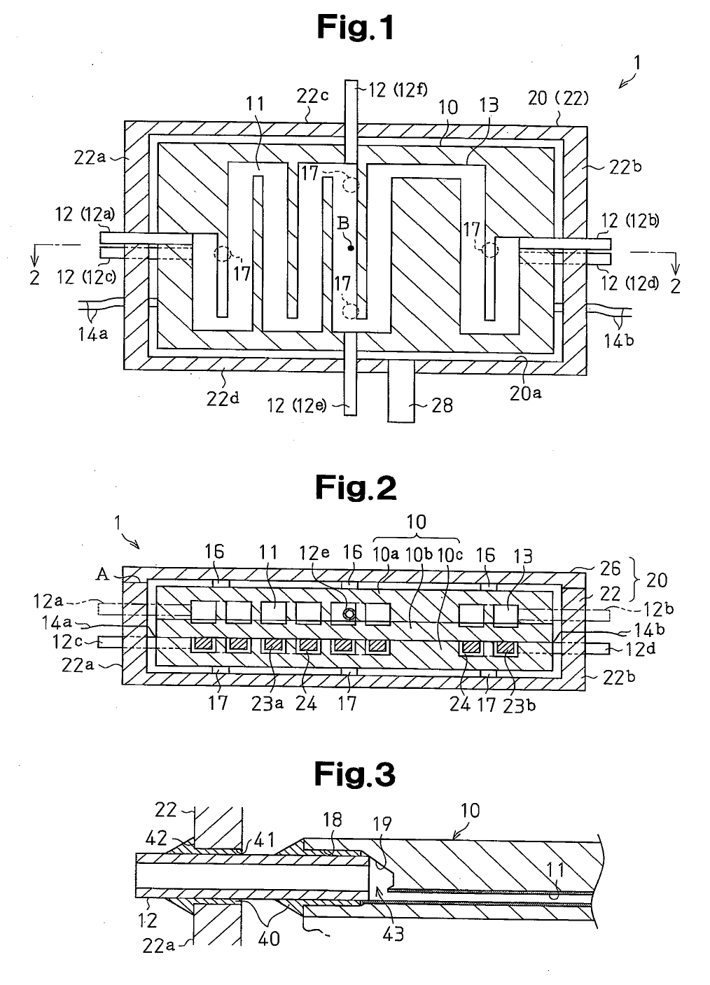

As shown in FIGS. 1 and 2, a fuel cell fuel reformer 1 according to a preferred embodiment of the present invention has a reformer body 10 serving as a gas reactor, an external container 20 accommodating the reformer body 10, thin-film heaters 23a and 23b serving as an electric heater, electric wires (lead wires) 14a and 14b respectively supplying electric power to the thin-film heaters 23a and 23b, and a plurality of fluid tubes 12 extending through the external container 20 and connected to the reformer body 10.

The external container 20 has a plurality of receiving portions, or supporting surfaces 41 that define through holes for receiving and supporting the electric wires 14a and 14b and the fluid tubes 12. As shown in FIG. 3, a low melting point glass sealant 40 is applied to the supporting surfaces 41 to seal the gap between each of the supporting surfaces 41 and the corresponding electric wires 14a and 14b or the fluid tube 12 to maintain vacuum in an inner vacuum chamber 20a of the external container 20.

The reformer body 10 is a superimposition of a reforming reaction substrate 10a, a main substrate lob, and a combustion reaction substrate 10c. The main substrate 10b is sandwiched between the reforming reaction substrate 10a and the combustion reaction substrate 10c. The substrates 10a, 10b, and 10c are, for example, 40 mm×30 mm rectangular substrates having a thickness of 1 mm. Grooves are formed in one surface of the main substrate 10b and in one surface of the reforming reaction substrate 10a. When the substrates 10b and 10a are bonded with each other, the grooves cooperate to define a reforming reaction channel 11 and an oxidation reaction channel 13. The reforming reaction channel 11 is in communication with the oxidation reaction channel 13 (see FIG. 1). Grooves are formed in one surface of the combustion reaction substrate 10c. The grooves define a combustion reaction channel 24 when the main substrate 10b is bonded with the combustion reaction substrate 10c. The combustion reaction channel 24 is located on one side of the main substrate 10b, while the reforming reaction channel 11 and oxidation reaction channel 13 are located on the other side of the main substrate 10b. The combustion reaction channel 24 preferably extends along the reforming reaction channel 11 and the oxidation reaction channel 13 (see FIG. 2). The surfaces of the main substrate 10b, the combustion reaction substrate 10c,and the reforming reaction substrate 10a may be bonded with each other by an adhesive or through anodic oxidation.

The thin-film heaters 23a and 23b are arranged in and along the combustion reaction channel 24. Specifically, the left thin-film heater 23a (as viewed in FIGS. 1 and 2) is accommodated in the combustion reaction channel 24, which opposes the reforming reaction channel 11. The right thin-film heater 23b is accommodated in the combustion reaction channel 24, which opposes the oxidation reaction channel 13. The electric wires 14a and 14b are respectively connected to the thin-film heaters 23a and 23b. Different portions of the combustion reaction channel 24 may be controlled at different temperatures by appropriately controlling the electric supply from the electric wires 14a and 14b.

The plurality of fluid tubes 12 include a fuel inlet tube 12a for drawing non-reformed fuel (e.g., aqueous methanol) into the reformer body 10, a fuel discharge tube 12b for discharging reformed fuel (hydrogen rich gas) from the reformer body 10, a combustion fuel inlet tube 12c, a combustion fuel discharge tube 12d, an oxygen inlet tube 12e for oxidation reaction, and an oxygen inlet tube 12f for combustion reaction. The term “fluid tubes 12” as used herein shall generally refer to tubes having these five functions.

The fuel inlet tube 12a is connected to the left end (upstream end) of the reforming reaction channel 11 to draw aqueous methanol into the reforming reaction channel 11. The fuel discharge tube 12b is connected to the right end (the downstream end) of the oxidation reaction channel 13 to discharge reformed fuel (hydrogen rich gas) from the oxidation reaction channel 13. The combustion fuel inlet tube 12c is connected to the left end (upstream end) of the combustion reaction channel 24 to draw in combustion fuel. The combustion fuel discharge tube 12d is connected to the right end (downstream end) of the combustion reaction channel 24 to discharge combustion residue. The oxygen inlet tube 12e is connected to a point directly upstream of the oxidation reaction channel 13 to draw in oxygen for oxidation reaction. The oxygen inlet tube 12f is connected to the combustion reaction channel 24 to draw in oxygen for combustion reaction.

The reforming reaction will now be described. The reforming reaction produces hydrogen and carbon dioxide from aqueous methanol using heat energy generated by the combustion reaction and heat energy generated by the thin-film heater 23a provided on the inner wall of the combustion reaction channel 24. Refer to formula (1).
CH₃OH+H₂O→3H₂+CO₂ (1)

The reforming reaction occurs in the reforming reaction channel 11. A reaction catalyst layer is provided on the inner wall surface of the reforming reaction channel 11. The reaction catalyst layer contains, for example, Cu, Zn, or Al₂O₃. The reaction temperature is generally preferably about 300° C. The preferable reaction temperature depends on the type of catalyst and may be about 200 to 400° C. depending on the type of catalyst.

The product of the reforming reaction of the formula (1) not only contains hydrogen (H₂) and carbon dioxide (CO₂) but actually also contains a trace amount of carbon monoxide (CO). The gas generated in the reforming reaction channel 11 flows into the oxidation reaction channel 13. The oxidation reaction channel 13 brings the reaction product into contact with oxygen to remove the carbon monoxide CO remaining in the reaction product. Refer to formula (2) shown below. The oxidation reaction channel 13 functions as a carbon monoxide removal portion.
CO+(½)O₂→CO₂ (2)

An oxidation catalyst layer is provided on the inner wall surface of the oxidation reaction channel 13. The oxidation catalyst layer is formed of a selective oxidation catalyst such as Pt or Al₂O₃. The carbon monoxide is oxidized to carbon dioxide by oxygen supplied from the oxygen inlet tube 12e and the oxidation catalyst layer in the oxidation reaction channel 13. The carbon dioxide is discharged into the atmosphere through the fuel discharge tube 12b.

Hydrogen is supplied to the fuel cell apparatus through the fuel discharge tube 12b to be utilized for power generation. The reformer 1 is designed to perform the fuel reforming and the oxidation of carbon monoxide simultaneously or in parallel. For example, the combustion reaction may be performed in the combustion reaction channel 24 to reduce power consumption, while the heat energy generated by the combustion reaction may be supplied from the main substrate 10b to the reforming reaction. A combustion catalyst layer is provided on the inner wall surface of the combustion reaction channel 24. The combustion catalyst layer contains, for example, a Fe₂O₃/Al₂O₃ mixture, Pt/Al₂O₃ mixture, or Pd/Al₂O₃ mixture.

The reformer body 10 is accommodated in the external container 20, which is made of glass and has a rectangular parallelepiped inner vacuum chamber 20a maintained in a vacuum atmosphere. As shown in FIG. 2, the external container 20 includes a thermally molded, bottomed, and box-shaped lower glass container 22 and an upper glass container 26 covering the top opening of the lower glass container 22. The lower and upper glass containers 22 and 26 are bonded with each other at contact surfaces (bonding portion A) in a hermetic state to define the inner vacuum chamber 20a.

Before bonding together the lower and upper glass containers 22 and 26 to form the external container 20, the inner surfaces of the glass containers 22 and 26 are coated with a chromium (Cr) film functioning as an underlayer film, and a gold (Au) film (not shown) is formed on the chromium film so as to function as an infrared ray reflecting film. The films are formed by a sputtering method. The infrared ray reflecting film may be formed by other methods such as vacuum deposition, plating, or fine particle application. The infrared ray reflecting film may be formed of a material having high infrared reflectance other than gold, such as silver, copper, or aluminum. The underlayer film may be made of any material, such as Cr, Ti, or W, as long as the material achieves satisfactory adhesion with glass and is difficult to alloy with a metal when heated.

The arrangement of the plurality of (six) fluid tubes 12 and the connection structure of the fluid tubes 12 will now be described.

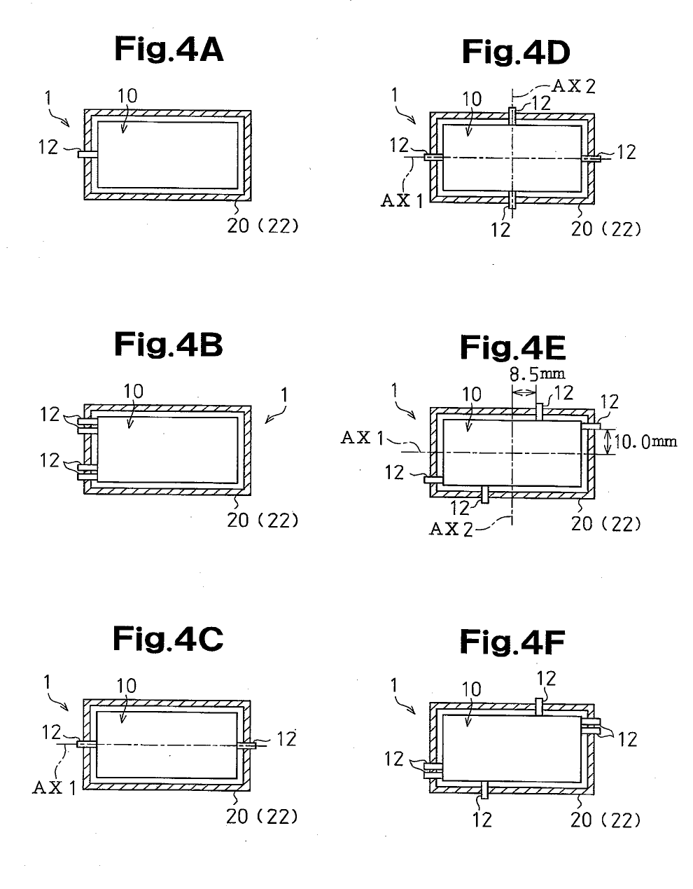

As shown in FIG. 1, the six fluid tubes 12 are arranged at symmetrical positions with respect to the center point B of the fuel reformer 1 when viewed from above and extends through the lower glass container 22 of the external container 20. As shown in FIG. 1, the left wall 22a and the right wall 22b of the lower glass container 22 each include two of the fluid tubes 12. The two fluid tubes 12 of the left wall 22a and the two fluid tubes 12 of the right wall 22b are arranged at symmetrical positions with respect to the center point B. As shown in FIG. 1, the rear wall 22c and the front wall 22d of the lower glass container 22 each include one oxygen inlet tube 12. The fluid tube 12 of the rear wall 22c and the fluid tube 12 of the front wall 22d are arranged at symmetrical positions with respect to the center point B and lie along the center line or thermal expansion axis, which extends through the center point B. Refer to FIG. 4D.

More specifically, the left wall 22a is provided with the fuel inlet tube 12a and the combustion fuel inlet tube 12c, and the right wall 22b is provided with the fuel discharge tube 12b and the combustion fuel discharge tube 12d. The rear wall 22c is provided with the oxygen inlet tube 12f, and the front wall 22d is provided with the oxygen inlet tube 12e.

The six fluid tubes 12 (12a to 12f) extend through the side walls 22a to 22d of the lower glass container 22. The low melting point glass sealant 40 seals the gaps between the outer surfaces of the fluid tubes 12 and the side walls 22a to 22d of the lower glass container 22 to keep the lower glass container 22 in a hermetic state. For example, the two fluid tubes 12 (the fuel inlet tube 12a and the combustion fuel inlet tube 12c) extending through the left wall 22a of the lower glass container 22 are in contact with the low melting point glass sealant 40 that is applied to the supporting surface 41 and part of the outer surface 42 of the left wall 22a. However, the two fluid tubes 12 do not directly contact the left wall 22a (see FIG. 3). In the same manner, the remaining four fluid tubes 12 are in contact with the low melting point glass sealant 40 that is applied to the supporting surfaces of the through holes and the outer surfaces of the corresponding side walls of the lower glass container 22 but are not directly in contact with the lower glass container 22.

The inner ends of the fluid tubes 12 are fixed to the reformer body 10 in communication with the channel 11 (13, 24). For example, the inner end of the fluid tube 12 extending through the left wall 22a (the fuel inlet tube 12a in FIG. 3) is fixed to the reformer body 10 and sealed by the low melting point glass sealant 40, which is applied to a receiving hole 18 formed in the reformer body 10.

A tapered surface 19 is formed in each receiving hole 18 to position the inner end of the corresponding fluid tube 12. When the fluid tube 12 is in contact with the tapered surface 19, a gap 43 is formed between the fluid tube 12 (the fuel inlet tube 12a in FIG. 3) and the reforming reaction channel 11 of the reformer body 10. The gap 43 reduces the flow resistance of fuel between the fluid tube 12 and the reforming reaction channel 11. The tapered surface 19 may be either a flat slope or a curved slope. Like the inner ends of the two fluid tubes 12 (12a and 12c) extending through the left wall 22a, the inner ends of the other four fluid tubes 12 (12b, 12d, 12e, and 12f) are also fixed and sealed in an hermetic state by the low melting point glass sealant 40 applied to the receiving holes 18 formed in the reformer body 10.

The interior of the external container 20 is maintained in a high vacuum of at least 1 Pa or less. If the degree of vacuum exceeds 1 Pa, heat conduction will occur in the gas and increase energy loss while raising the temperature of the external container 20.

After the lower and upper glass containers 22 and 26 are bonded to each other to form the external container 20, the air in the external container 20 is discharged through the exhaust tube 28, which extends through the front wall 22d of the glass container 22, to vacuum-seal the glass container 22. The reformer body 10 is preferably spaced from the lower glass container 22 by at least 0.2 mm or more, and-the upper glass container 26 is preferably spaced from the reformer body 10 by at least 0.2 mm or more. To provide such spaces, spacers or support members 16 and 17 are formed integrally with the lower and upper glass containers 22 and 26 oh opposite sides of the reformer body 10. Specifically, the lower glass container 22 is integrally formed with four support members 16 of the same glass material as the lower container, which has low heat conductivity (see FIG. 2). The support members 16 are circular columns having a diameter of 1 mm. Similarly, the upper glass container 26 is formed with four support members 17 of the same glass material as the upper container, which has low heat conductivity (see FIGS. 1 and 2). The support members 17 are circular columns having a diameter of 1 mm.

The supporting surfaces 41 of the through holes in the side walls 22a to 22d and the four support members 16 of the lower glass container 22 are formed at the time as when the lower glass container 22 is thermally molded. The four support members 17 of the upper glass container 26 are also formed at the same time as when the upper glass container 26 is thermally molded.

The four support members 16 and the four support members 17 are each formed from-a glass material, which has low heat conductivity, and shaped into a circular column having a diameter of 1 mm in order to minimize the contact surface area between the lower glass container 22 and the reformer body 10 and the contact surface area between the upper glass container 26 and the reformer body 10. The support members 16 and support members 17 support the reformer body 10 in a state spaced from the inner surfaces of the external container 20 by a distance of at least 0.2 mm or more (see FIG. 2).

Accordingly, three or more support members 16 and three or more support members 17 are required to support the reformer body 10 so that the reformer body 10 does not contact the inner surfaces of the lower and upper glass containers 22 and 26 forming the external container 20. The shape of the support members 16 and the support members 17 is not limited to a circular column and may be a rectangular column. The ends of the support members 16 and support members 17 contacting the reformer body 10 may have a spherical or flat surface. Further, the diameter (when the supports members are circular columns) or the diagonal length (when the supports members are rectangular columns) of the support members 16 and 17 should be as small as possible in order to inhibit heat conduction (heat conduction due to direct contact between members). However, the desirable the diameter is not limited to 1 mm and may be about 0.2 mm to 1.5 mm.

The electric wires 14a and 14b supplying power to the thin-film heaters 23a and 23b in the reformer body 10 also extend through the side walls 22a and 22b of the lower glass container 22, in the same manner as the fluid tubes 12 (see FIGS. 1 and 2). The portions receiving the electric wires 14a and 14b are all sealed in a hermetic state by a low melting point glass sealant (not shown). The electric wires 14a and 14b are, for example, formed of KOVAR having a thermal expansion coefficient that is close to that of the low melting point glass sealant. The KOVAR wires exhibit high affinity with the glass of the lower glass container 22. When using KOVAR wires, no vacuum leakage is observed at portions where the KOVAR wires are sealed by the low melting point glass sealant. The electric wires 14a and 14b are not limited to KOVAR wires but may be iron/nickel alloy wires or DUMET wires formed by coating an iron/nickel alloy core with a copper layer.

In the fuel reformer 1, the tensile stress generated in the fluid tubes 12 decreases as the difference in thermal expansion between reformer components (the reformer body 10, the external container 20, and the fluid tubes 12) decreases. Therefore, it is preferable that the difference in thermal expansion between the reformer components be small. Since the temperature of the reformer body 10 becomes as high as 200° C. to 400° C., it is preferable that the thermal expansion coefficient of the reformer body 10 be as low as possible. Although it is most preferable that the thermal expansion coefficient of the reformer body 10 be zero, a material having a thermal expansion coefficient of zero has poor processability and increases cost. Accordingly, it is practically difficult to form the reformer body 10 from a material having a thermal expansion coefficient of zero. Therefore, the preferable material for the reformer body 10 is an inexpensive glass having a stable and low thermal expansion (e.g., glass having a thermal expansion coefficient of 33×10⁻⁷ (1/° C.))

From the perspective of the stress caused by thermal expansion, the reformer body 10 may be formed of a material having low heat conductivity such as silicon or ceramic instead of glass. The reformer components other than the reformer body 10, namely the fluid tubes 12, the low melting point glass sealant 40, and the external container 20 preferably have the same thermal expansion coefficient as that of the reformer body 10. In the preferred embodiment, the thermal expansion coefficient of the glass-made fluid tubes 12 and external container 20 is equal to the thermal expansion coefficient of the reformer body 10 that is 33×10⁻⁷ (1/° C.).

The quantity and arrangement of the fluid tubes 12 will now be described.

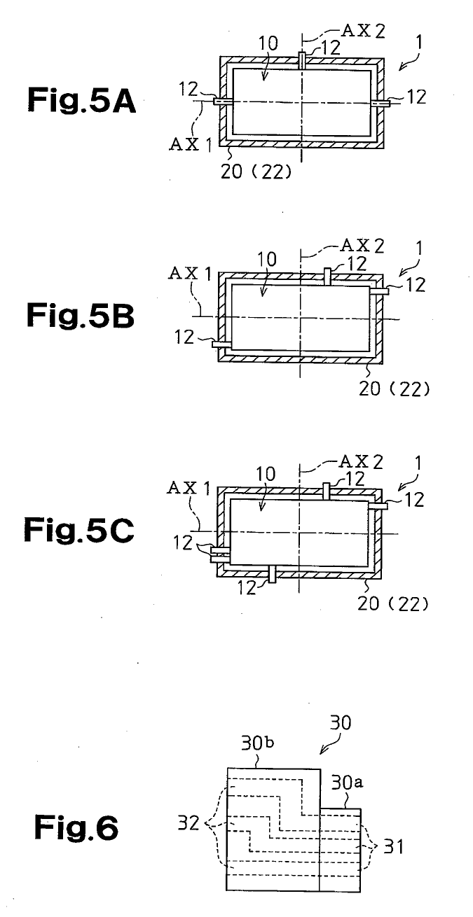

FIGS. 4A to 4F show examples of the fuel reformer 1 according to the preferred embodiment of the invention. The examples differ in quantity of fluid tubes 12 and in positions of the fluid tubes 12 fixed to the external container 20. FIGS. 5A to SC show comparative examples. The examples of FIGS. 4A to 4F and the comparative examples of FIGS. 5A to SC were evaluated for occurrence of cracks and vacuum leakage.

In the examples of FIGS. 4A to 4F and the comparative examples of FIGS. 5A to 5C, the thermal expansion coefficient of the glass-made fluid tubes 12 and external container 20 was equal to the thermal expansion coefficient of the reformer body 10, that is 33×10⁻⁷ (1/° C.). Only the low melting point glass sealant 40 has a different thermal expansion coefficient of 41×10⁻⁷ (1/° C.). The fluid tubes 12 have an outer diameter of 1.6 mm and an inner diameter of 1.0 mm.

The examples and the comparative examples were checked to determine whether or not the vacuum could be maintained when the temperature of the thin-film heater 23a in the reformer body 10 was kept at 300° C. The maintenance of vacuum was checked by forcibly discharging gases from the external container 20 with a vacuum pump through the exhaust tube 28. A vacuum of 1 Pa was achieved by the forcible discharge in the external container 20. Then, power was supplied to the thin-film heater 23a of the reformer body 10 to keep the temperature of the reformer body 10 at 300° C. While constantly blasting He gas against the fuel reformer 1, an He leak detector was used to detect whether or not any cracks or breakage had occurred in the glass fluid tubes 12, the low melting point glass sealant 40, and the glass containers 22 and 26 of the external container 20.

In the examples of FIGS. 4A and 4B, the fluid tubes 12 were arranged collectively on one side of the reformer body 10 to extend through the side of the external container 20 facing that side. Ten samples of the fuel reformers 1 having such structures were prepared and evaluated. None of the samples exhibited cracks or breakage and a vacuum state were maintained in all of the samples.

In the examples shown in FIGS. 4C and 4D, the fluid tubes 12 were arranged along center lines or the thermal expansion axes (AX1 and AX2), that is, each fluid tube 12 is arranged at the center of the corresponding sides of the reformer body 10 and the external container 20. In the example of FIG. 4C, the fluid tubes 12 were arranged on two opposite sides and in the example of FIG. 4D, the fluid tubes 12 were respectively arranged on the centers of four sides so that the fluid tubes 12 extend outwards through the external container 20. In other words, the two opposite fluid tubes 12 are aligned on the center line of the corresponding sides of the reformer body 10 and the external container 20. Ten samples of the fuel reformers 1 for each of these structures were prepared and evaluated. None of the samples exhibited cracks or breakage, and the vacuum state was maintained in all of the samples.

In the example shown in FIGS. 4E and 4F, the fluid tubes 12 were arranged on the four sides of the reformer body 10 such that the fluid tubes 12 were located at symmetrical positions with respect to the center point B shown in FIG. 1.

In the example shown in FIG. 4E, the same quantity of the fluid tubes 12 were arranged on each of the four sides. The fluid tubes 12 arranged on the upper and lower sides were spaced from the thermal expansion axis AX2 by 8.5 mm. The fluid tubes 12 arranged on the left and right sides were spaced from the thermal expansion axis AX1 by 10 mm.

In the example shown in FIG. 4F, the same quantity of the fluid tubes 12 were arranged on two opposite sides. Ten samples were prepared and evaluated for each of the examples of FIGS. 4E and 4F. None of the samples exhibited cracks or breakage, and the vacuum was maintained in all of the samples.

In the comparative example shown in FIG. 5A, the fluid tubes 12 were arranged along the thermal expansion axes (AX1 and AX2). However, no fluid tube 12 was arranged on the side wall opposite the fluid tube 12 arranged along the thermal expansion axis AX2. Five out of ten samples having the arrangement of FIG. 5A exhibited breakage in part of the fluid tubes 12, and none of the ten samples were able to maintain a vacuum state.

FIG. 5B shows an arrangement in which one of the fluid tubes 12 was removed from the arrangement in FIG. 4E. Five out of ten samples having the arrangement shown in FIG. 5B exhibited breakage in part of the fluid tubes 12, and none of the ten samples were able to maintain a vacuum state.

In the comparative example shown in FIG. 5C, the fluid tubes 12 were arranged on four sides in the same manner as the examples of FIGS. 4E and 4F. However, the quantities of the fluid tubes 12 differ on two opposite sides. The fluid tubes 12 were partially broken in all of ten samples for this comparative example.

Even if the fluid tubes 12 were arranged as shown in FIG. 4D, seven out of ten samples did not maintain a vacuum state when the fluid tubes 12 were sealed by the low melting point glass sealant 40 that was applied only to the outer surface 42 of the external container 20. In contrast, all of ten samples were maintained in a vacuum state when the fluid tubes 12 were arranged in the same manner but sealed by the low melting point glass sealant 40 applied to the two surfaces of the external container 20, namely, part of the outer surface 42 of the left wall 22a and the supporting surfaces 41 defining the through holes as shown in FIG. 3.

The fuel reformer 1 of the preferred embodiment was evaluated as follows.

Power was supplied to the thin-film heaters 23a and 23b in the reformer body 10 and the temperature was measured at various parts. When a power of 1.5 W was supplied to the thin-film heaters 23a and 23b, the reformer body 10 was heated to 300° C. The temperature at a central part of the glass container 26 was 55° C. while the temperature at the corners thereof was 50° C.

For comparison, the temperature was measured at various parts of a fuel reformer having the same configuration as the fuel reformer 1 according to the preferred embodiment but having KOVAR tubes instead of glass tubes as the fluid tubes 12. In order to minimize heat conduction, the KOVAR tubes employed were extremely fine tubes having an outer diameter of 1.0 mm and an inner diameter of 0.05 mm. In this comparative example, a plurality of fluid tubes (KOVAR tubes). 12 were arranged as shown in FIG. 4B. A power of about 3.5 W, that is, more than twice the power supplied for the fuel reformer 1 of the preferred embodiment, was supplied to the thin-film heater 23a in order to heat the reformer body 10 to 300° C. and to keep the reformer body 10 at 300° C.

The preferred embodiment has the advantages described below.

The reformer body 10, the plurality of fluid tubes 12, and the external container 20 are all made of glass. This substantially reduces the heat conduction due to direct contact between the components. Thus, a vacuum insulated reformer 1 with a minimum energy loss is achieved.

The thermal expansion coefficient of the glass fluid tubes 12 and external container 20 is equal to the thermal expansion coefficient of the reformer body 10 that is 33×10⁻⁷ (1/° C.). Accordingly, the thermal expansion of the reformer body 10 is reduced, and thus the difference in thermal expansion between the external container 20 and the reformer body 10 and the difference in thermal expansion between the fluid tubes 12 and the reformer body 10 are also reduced. This lowers the tensile stress generated in the fluid tubes 12 which are connected to the reformer body 10, extending through the external container 20 in a vacuum tight state. Consequently, the occurrence of cracks or breakage in the glass fluid tubes 12 or in the joint portion (the low melting point glass sealant 40) between the fluid tubes 12 and the external container 20 keep the inside of the external container 20 in a vacuum state.

As shown in FIG. 1, the six fluid tubes 12 are arranged on the four side walls 22a to 22d of the external container 20 such that they are located at symmetrical positions with respect to the center point B when the fuel reformer 1 is viewed from above. This arrangement balances the stresses generated in the fluid tubes 12 and reduces torsional stress. Thus, the occurrence of cracks or breakage in the glass-made fluid tubes 12 is prevented.

Even when the plurality of fluid tubes 12 are arranged at the symmetrical positions as described above, a fuel reformer 1 having a double wall structure in which the reformer body 10 and the external container 20 are connected by the fluid tubes 12 cannot be formed if the thermal expansion of the reformer body 10 is too high. For example, if a low melting point glass having a large difference in thermal expansion (of 30×10⁻⁷ (1/° C.) or more) is used between the components (between the reformer body 10 and the external container 20, or between the reformer body 10 and the fluid tubes 12), high residual stress will be generated due to the difference in thermal expansion when the molten glass is slowly cooled. This will cause the occurrence of cracks or breakage in the glass fluid tubes 12, and a vacuum state thus cannot be maintained.

In the preferred embodiment, the thermal expansion coefficient of the glass-made fluid tubes 12 and external container 20 is equal to the thermal expansion coefficient of the reformer body 10, that is 33×10⁻⁷ (1/° C.). This inhibits the generation of high residual stress due to the difference in thermal expansion and prevents the occurrence of cracks or breakage in the glass-made fluid tubes 12. Consequently, the production of a compact fuel reformer 1 having a double wall structure in which the reformer body 10 and the external container 20 are connected by the fluid tubes 12 is enabled.

As shown in FIG. 3, the receiving portions formed in the side wall 22a to 22d for receiving the plurality of fluid tubes 12 are hermetically sealed by the low melting point glass sealant 40. Therefore, the vacuum leakage at the receiving portion of the fluid tubes 12 is effectively prevented.

If a plurality of fluid tubes 12 are arranged on two, three, or four sides (on two, three or four side walls) of the external container 20, and the fluid tubes 12 are sealed only at the outside of the external container 20, high stress will be generated and the sealing portion of the fluid tubes 12 will be susceptible to cracks or the like. This is because when the fluid tubes 12 are sealed only at the outside of the external container 20, the length of the fluid tubes 12 is increased and the stress generated therein due to thermal expansion is also increased to a level that the sealing portion of the fluid tubes 12 cannot resist the stress.

In the preferred embodiment, the six fluid tubes 12 are hermetically sealed by the low melting point glass sealant 40 that is applied to the supporting surfaces 41 defining the through holes formed in the side walls of the glass container 22 and on part of the outer surface 42 of the glass container 22 (see FIG. 3). This reduces the length of the fluid tubes 12 and thus reduces the stress generated due to thermal expansion. Accordingly, the occurrence of cracks or the like in the sealing portions of the fluid tubes 12 are prevented.

As shown in FIG. 3, the inner ends of the fluid tubes 12 are fixed to the receiving holes 18 formed in the reformer body 10 in an hermetic state by the low melting point glass sealant 40. This not only facilitates the connection of the inner ends of the fluid tubes 12 to the reformer body 10 but also seals the fluid tubes 12 in the receiving holes 18 with the low melting point glass sealant 40. Accordingly, resistance to stress is increased.

A tapered surface 19 is formed in each of the receiving holes 18 to position the inner end of the fluid tube. 12. When the inner end of the fluid tube 12 is in contact with the tapered surface 19, a gap 43 is defined between the fluid tube 12 and the reforming reaction channel 11 of the reformer body 10. The gap 43 reduces the flow resistance of the fuel flow between the fluid tube 12 and the reforming reaction channel 11. Moreover, the tapered surface 19 reduces the resistance of flow between the fluid tube 12 and the reforming reaction channel 11 even if the opening size of the reforming reaction channel 11 of the reformer body 10 does not match the size of the inner end of the fluid tube 12. These features are effective for reducing the size of the fuel reformer 1.

The external container 20 is formed by bonding the bottomed box-shaped lower and upper glass containers 22 and 26 at the bonding portion A as shown in FIG. 2. This forms the supporting surfaces 41 of the through holes in the side walls and the four support members 17 of the lower glass container 22 at the same time as when the lower glass container 22 is thermally molded. Further, the four support members 16 of the upper glass container 26 are formed at the same time as the thermal molding of the upper glass container 26. Accordingly, no post-processing is required to form the supporting surfaces 41 of the through holes in the external container 20 or to form the support members 17 and 16. The production cost is thus reduced and the fuel reformer 1 is provided with a low cost. The reformer body 10 have electric heaters (thin-film heaters 23a and 23b) accommodated in the external container 20, which is maintained in a vacuum state. Therefore, the size of the fuel reformer 1 may be reduced while lowering the energy loss caused by heat conduction due to convection of gas such as air.

A gold (Au) film (not shown) serving as an infrared ray reflecting film is formed by the sputtering method on the chromium (Cr) film formed as the underlayer film on the inner surfaces of the lower and upper glass containers 22 and 2. This prevents the transmission of infrared rays through the glass containers 22 and 26 forming the external container 20. Thus, a compact fuel reformer 1 in which the energy loss caused by infrared radiation is reduced may be manufactured.

The lower glass container 22 includes the four support members 17 made of the same glass material as the lower glass container 22 and having low heat conductivity. The support members 17 are shaped into circular columns with a diameter of 1 mm. The upper glass container 26 also includes the four support members 16 made of the same material as the upper glass container 26 and having low heat conductivity. The support members 16 are shaped into circular columns with a diameter of 1 mm. In this manner, in the fuel reformer 1 serving as the heating element, the contact area between the lower and upper glass containers 22 and 26 of the external container 20 is decreased. Further, the support members 17 and 16 at which the components are in contact with each other are formed of a material having low heat conductivity. Accordingly, a compact fuel reformer 1 may be manufactured while reducing energy loss that would be caused by heat conduction due to direct contact between the reformer components.

In general, metal has a heat conductivity of about 17 (W/mK). Glass has a heat conductivity of about 0.75 (W/mK), which is 1/20 or less than that of the metal. According to the preferred embodiment, the maximum thermal expansion coefficient is ten times or less than the minimum thermal expansion coefficient among the thermal expansion coefficients of the reformer components, namely the reformer body 10, the fluid tubes 12, the external container 20, and the sealant 40. This reduces the heat conduction caused by direct contact between the reformer components and enables the manufacturing of a vacuum insulated fuel reformer 1 having low energy loss.

During the use of the fuel cell fuel reformer 1, the temperature of the reformer body 10 having the electric heaters 23a and 23b reaches about 200° C. to 400° C., whereas the temperature of the external container 20 must be kept low, at about 50° C. The reformer body 10 thermally expands significantly, whereas the external container 20 thermally expands subtly. Therefore, the difference in thermal expansion between the reformer body 10 having high thermal expansion and the external container 20 having low thermal expansion may generate of high tensile stress that exceeds the breakdown strength of the glass in the fluid tubes 12, which are connected to the reformer body 10 while extending through the external container 20 so as to maintain the inner vacuum chamber 20a in an hermetic state. Such tensile stress will cause cracks or breakage in the glass-made fluid tubes 12 or in the joint portions between the fluid tubes 12 and the external container 20 and make it impossible to maintain the inner vacuum chamber 20a of the external container 20 in a vacuum state. Such problem may arise when a reforming reactor and a heat-insulated container are welded with metal tubes like in the fuel cell apparatus described in Patent Publication 2. In contrast, according to the present invention, the thermal expansion of the external container 20 is low, and the difference in thermal expansion between the external container 20 and the reformer body 10 is small. This reduces the tensile stress generated in the fluid tubes 12 which are connected to the reformer body 10 while extending through the external container 20 so as to maintain the vacuum and hermetic state. Thus, the occurrence of cracks or breakage in the glass-made fluid tubes 12 or the joint portions between the fluid tubes 12 and the external container 20 is prevented. Consequently, the inner vacuum chamber 20a. of the external container 20 is maintained in a vacuum state.

The thermal expansion coefficient of the reformer body 10 should be as low as possible to reduce the tensile stress generated in the fluid tubes. However, a low-expansion glass (glass having a low thermal expansion coefficient) generally has a high melting point and is difficult to process. According to the present invention, the thermal expansion coefficient of the reformer body 10 is set within the range described above to enable the selection of an optimum glass material for the reformer body 10 in consideration of both thermal expansion and processability.

In the examples shown in FIGS. 4A and 4B, all the fluid tubes 12 are collectively arranged in one side wall of the reformer body 10. In this arrangement, the reformer body 10 is supported by the fluid tubes 12 on one side, and hence the fluid tubes 12 are subjected to relatively low stress even if the temperature of the reformer body 10 is increased. This prevents the occurrence of cracks or breakage in the fluid tubes 12.

In general, thermal expansion of the fluid tubes 12 is obtained by synthesizing axial displacement caused by axial stress and radial displacement caused by radial stress. The torsional stress acting on the fluid tubes 12 is increased as the distance from the center of thermal expansion of the reformer body 10 increases. In the examples of FIGS. 4c and 4d, the fluid tubes 12 are arranged on the four sides or on two opposite sides of the rectangular substrate along the thermal expansion axes, and extend through opposing side walls of the external container 20. In this arrangement, the generation of stress is limited to the axial direction of the fluid tubes. Thus, the generated stress is reduced. This prevents the occurrence of cracks or breakage in the glass-made fluid tubes.

It should be apparent to those skilled in the art that the present invention may be embodied in many other specific forms without departing from the spirit or scope of the invention. Particularly, it should be understood that the present invention may be embodied in the following forms.

The plurality of (six) fluid tubes 12 in the preferred embodiment may be partially replaced with a tube assembly 30 as shown in FIG. 6. Three channels are formed in the tube assembly 30. The tube assembly 30 includes a small-diameter portion 30a having three fuel inlet ports (fluid inlet ports) 31, and a large-diameter portion 30b having three fuel outlet ports (fluid outlet ports) 32. The tube assembly 30 is, for example, attached to the external container 20 on the side of the small-diameter portion 30a, and to the reformer body 10 on the side of the large-diameter portion 30b. The use of such tube assembly 30 reduces the number of positions in the external container 20 where the fluid tubes are extended through and sealed. This reduces the procedures required to assemble the fuel reformer 1. Consequently, the fuel reformer 1 is manufactured with low cost.

In the preferred embodiment, the plurality of (six) fluid tubes 12 are hermetically sealed by the low melting point glass sealant 40 that is applied to the supporting surfaces 41 defining the through holes formed in the side walls of the glass container 22 and to part of the outer surface 42 of the glass container 22. However, the present invention is not limited in such a manner. The fluid tubes 12 may extend through the side walls of the glass container 22 and be sealed at the outer and inner surfaces of the side walls.

In the preferred embodiment, the reformer body 10 (including the reforming reaction substrate 10a, the main substrate 10b,and the combustion reaction substrate 10c), the fluid tubes 12, and the external container 20 are all made of the same glass material so that they have the same thermal expansion coefficient, while the sealant 40 has a different thermal expansion coefficient. It is obviously desirable that all the components have the thermal expansion coefficient. However, this would be difficult due to various conditions. Thus, the thermal stress in which heating does not cause breakage even if the thermal expansion coefficient differs among components was calculated and checked. The calculation of stress was conducted in accordance with the finite element method.

Specifically, the thermal expansion coefficient αR of the substrates 10a to 10c of the reformer body 10 serving as a gas reactor was varied. When the thermal expansion coefficient αR differed from the thermal expansion coefficient αP of the external container 20 and the thermal expansion coefficient αG of the fluid tubes 12 and sealant 40, the range in which the components would not be broken by the generated stress was evaluated. The tolerable stress values, at which breakage does not occur, were used as references, and was 34 MPa (350 kg/cm²) for the substrates 10a to 10c of the reformer body 10, 39 MPa (400 kg/cm²) for the external container 20, 78 MPa (800 kg/cm²) for the fluid tubes 12, and 39 MPa (400 kg/cm²) for the sealant 40.

Table 1 shows the results of evaluation of the examples shown in FIGS. 4A and 4B. The stress generated in the components was calculated while varying the thermal expansion coefficient αR of the substrates 10a to 10c of the reformer body 10 (referred to as “substrates” in the table), the difference ΔαP (=αR−αP) between the thermal expansion coefficient αR and the thermal expansion coefficient αG of the external container 20, and the difference ΔαG (=αR−αG) between αR and the thermal expansion coefficient αG of the fluid tubes 12 (referred to as “tubes” in the table) and sealant 40.

TABLE 1

| | | | | Generated |
|---|---|---|---|---|
| | ΔαP | ΔαG | | stress (MPa) |
| αR | (=αR − | (=αR − | | Relevant components |
| (×10⁻⁷° C.⁻¹) | αP) | αG) | Evaluation | are in parentheses |
| 20 to 50 | ±10 | ±15 | ∘ | About 29 or less |
| | | | | (substrates, tubes, |
| | | | | sealant) |
| 60 | ±10 | ±15 | x | About 39 (substrate) |
| 20 to 50 | −15 | −15 | x | About 44 (sealant) |
| 20 to 50 | ±15 | +15 | x | About 44 (substrate) |
| 20 to 50 | ±10 | +20 | x | About 49 (sealant) |
| 20 to 50 | ±10 | −20 | x | About 44 (sealant) |

It can be seen from Table 1 that when the thermal expansion coefficient αR is in the range of 20×10⁻⁷ (1/° C.) to 50×10⁻⁷ (1/° C.), the difference ΔαP is in the range of ±10×10⁻⁷ (1/° C.), and the difference ΔαG is in the range of ±15×10⁻⁷ (1/° C.), the stress generated in the components is 34 MPa or less. This is in the range of stress values that will not cause breakage.

In this configuration, when the temperature of the reformer body 10 in the external container 20 increases, the heat is transmitted to one side of the external container 20 via the fluid tubes 12. Therefore, the generated stress is low.

However, even if ΔαP and ΔαG are within the ranges described above, the stress generated in the substrates 10a to 10c of the reformer body 10 is about 39 MPa, which exceeds the tolerable value when αR is 60×10⁻⁷ (1/° C.). Even if αP is within the range of 20×10⁻⁷ (1/° C.) to 50×10⁻⁷ (1/° C.), the stress generated in the substrates 10a to 10c of the reformer body 10 or in the sealant 40 exceeds the tolerable value when one of ΔαP and ΔαG exceeds the range of ±10×10⁻⁷ (1/° C.) or ±15×10⁻⁷ (1/° C.).

As apparent from the above results, when the fluid tubes 12 are collectively arranged on one side of the reformer body 10 shown in FIGS. 4A and 4B, the fuel reformer is more resistive to breakage by setting αP within the range of 20×10⁻⁷ (1/° C.) to 50×10⁻⁷ (1/° C.), ΔαP within the range of ±10×10⁻⁷ (1/° C.), and ΔαG within the range of ±15×10⁻⁷ (1/° C.).

Table 2 shows the results of evaluation of the examples in FIGS. 4E and 4F.

TABLE 2

| | | | | Generated |
|---|---|---|---|---|
| | ΔαP | ΔαG | | stress (MPa) |
| αR | (=αR − | (=αR − | | Relevant components |
| (×10⁻⁷° C.⁻¹) | αP) | αG) | Evaluation | are in parentheses |
| 20 to 50 | ±5 | ±10 | ∘ | About 29 or less |
| | | | | (substrates, tubes, |
| | | | | sealant) |
| 60 | ±5 | ±10 | x | About 34 (substrate) |
| 20 to 50 | −10 | ±10 | x | About 44 (sealant) |
| 20 to 50 | +10 | ±10 | x | About 54 (sealant) |
| 20 to 50 | ±5 | +15 | x | About 78 (sealant) |
| 20 to 50 | ±5 | −15 | x | About 59 (sealant) |

In the examples shown in FIGS. 4E and 4F, the fluid tubes 12 are arranged on the four sides of the reformer body 10 at symmetrical positions. In this case, stress tends to be generated more than when the fluid tubes 12 are arranged on one side as described above, and the conditions become more severe.

As apparent from Table 2, the generated stress exceeds the tolerable value even if αR is 50×10₋₇ (1/° C.) that is within the tolerable range when the fluid tubes 12 are arranged on one side as described above, and ΔαP and ΔαG are also within the tolerable ranges. In conclusion, αR should be set within the range of 20×10₋₇ (1/° C.) to 50×10₋₇ (1/° C.), ΔαP within the range of ±5×10₋₇ (1/° C.), and ΔαG within the range of ±10×10₋₇ (1/° C.). Breakage may occur if any one of these exceeds the tolerable range.

The same can be said for the evaluation results of the examples shown in FIGS. 4C and 4D in which the fluid tubes 12 are arranged on the thermal expansion axes. In the comparative example shown in FIG. 5A, the fluid tubes 12 are asymmetric in quantity. In this comparative example, the generated stress is high and breakage may occur even if the above conditions are satisfied.

In the comparative examples shown in FIGS. 5B and SC, the fluid tubes 12 are asymmetric in arrangement. It was found in these comparative examples that, even if all the thermal expansion coefficients were the same, stress of about 44 MPa was generated in the external container 20 and the sealant 40.

Even if the fluid tubes 12 are arranged on the thermal expansion axes as in the example of FIG. 4D, the magnitude of the stress generated in the external container 20 will become close to 44 MPa when the sealant 40 is applied only to the outside of the external container 20.

Therefore, it can be understood that the thermal expansion coefficients of the respective materials forming the reformer body 10, the fluid tubes 12, and the external container 20 and the thermal expansion coefficient of the sealant 40 must be at least in the same order. That is, it is at least required that the maximum thermal expansion coefficient value among the thermal expansion coefficients should be not more than ten times the minimum thermal expansion coefficient value. Additionally, the difference in thermal expansion coefficient must be further reduced by the appropriate arrangement of the fluid tubes 12.

The present examples and embodiments are to be considered as illustrative and not restrictive, and the invention is not to be limited to the details given herein, but may be modified within the scope and equivalence of the appended claims.

What is claimed is:

1. A fuel cell fuel reformer for use with non-reformed fuel, the fuel cell fuel reformer comprising:
a gas reactor for reforming non-reformed fuel to produce reformed fuel;
an electric heater that heats the gas reactor;
an external container including an inner vacuum chamber that accommodates the gas reactor and the electric heater, the external container further including a plurality of receiving portions;
an electric wire extending through the external container to supply electric power to the electric heater in the inner vacuum chamber;
a plurality of fluid tubes respectively received by the receiving portions and extending through the external container, at least one of the fluid tubes supplying the non-reformed fuel to the gas reactor in the inner vacuum chamber, and at least another one of the fluid tubes discharging the reformed fuel produced by the gas reactor; and
a sealant that seals gaps between the fluid tubes and the receiving portions;
wherein the gas reactor, the fluid tubes, the external container, and the sealant each have thermal expansion coefficients, with one of the coefficients being a maximum and another one being a minimum relative to the other coefficients, and the maximum one of the thermal expansion coefficients being no greater than ten times the minimum one of the thermal expansion coefficients.

2. The fuel reformer according claim 1, wherein the gas reactor, the fluid tubes, the external container, and the sealant are made of glass.

3. The fuel reformer according claim 1, wherein:
the thermal expansion coefficient of the gas reactor is in the range of 20×10₋₇ (1/° C.) to 50×10₋₇ (1/° C.);
the difference between the thermal expansion coefficient of the external container and the thermal expansion coefficient of the gas reactor is within ±10×10₋₇ (1/° C.); and
the difference between the thermal expansion coefficient of the fluid tubes and the thermal expansion coefficient of the gas reactor and the difference between the thermal expansion coefficient of the sealant and the thermal expansion coefficient of the gas reactor are both within ±15×10₋₇ (1/° C.).

4. The fuel reformer according claim 3, wherein:
the thermal expansion coefficient of the gas reactor is in a range from 20×10₋₇ (1/° C.) to 50×10₋₇ (1/° C.), the difference between the thermal expansion coefficient of the external container and the thermal expansion coefficient of the gas reactor is within ±5×10₋₇ (1/° C.); and
the difference between the thermal expansion coefficient of the fluid tubes and the thermal expansion coefficient of the gas reactor and the difference between the thermal expansion coefficient of the sealant and the thermal expansion coefficient of the gas reactor are both within ±10×10₋₇ (1/° C.).

5. The fuel reformer according claim 1, wherein:
the gas reactor includes a rectangular substrate;
the external container is a rectangular parallelepiped having four side walls; and
the fluid tubes are connected to one of the four sides of the rectangular substrate and extend through the side wall of the external container facing the one of the four sides.

6. The fuel reformer according claim 1, wherein:
the gas reactor includes a rectangular substrate;
the external container is a rectangular parallelepiped having four side walls;
the fluid tubes are arranged along at least one center lines of four sides or two opposite sides of the rectangular substrate and extend through the side walls of the external container facing the four sides or the two opposite sides of the substrate.

7. The fuel reformer according claim 1, wherein:
the gas reactor includes a rectangular substrate;
the external container is a rectangular parallelepiped having four side walls;
the fluid tubes are arranged at symmetrical positions with respect to the center point of a rectangle defined by four sides of the substrate of the gas reactor; and
the fluid tubes extend through opposing side walls of the external container.

8. The fuel reformer according claim 1, wherein the sealant is applied to supporting surfaces defining through holes in side walls of the external container to receive the fluid tubes and to part of an outer surface of the external container to hermetically fix the fluid tubes to the external container.

9. The fuel reformer according claim 8, wherein:
the gas reactor includes a substrate including a plurality of receiving holes;
inner ends of the fluid tubes are respectively arranged in the receiving holes; and
the sealant is applied between the inner ends of the fluid tubes and the substrate to hermetically fix the fluid tubes to the gas reactor.

10. The fuel reformer according claim 9, wherein:
the gas reactor has inner channels through which a fluid flows;
the receiving holes are in communication with the inner channels; and
a tapered surface is formed on the inner surface of each of the receiving holes to position the inner end of the corresponding fluid tube so as to define a gap between the inner end of the fluid tube and the corresponding inner channel.

11. The fuel reformer according claim 1, wherein some or all of the fluid tubes are formed by a tube assembly including a plurality of channels.

12. The fuel reformer according claim 1, wherein the gas reactor, the fluid tubes, the external container, and the sealant have the same thermal expansion coefficient.

13. The fuel reformer according claim 1, wherein the non-reformed fuel is aqueous methanol and the reformed fuel is hydrogen rich gas.
